(19) United States
(12) Patent Application Publication
(10) Pub. No.: US 2013/0212236 A1
(43) Pub. Date: Aug. 15, 2013

(54) M2M SERVICE ENABLEMENT OVER ACCESS NETWORKS

(71) Applicant: TELEFONAKTIEBOLAGET L M ERICSSON (PUBL), (US)

(72) Inventors: George Foti, Dollard des Ormeaux (CA); Ahmad Muhanna, Richardson, TX (US)

(73) Assignee: TELEFONAKTIEBOLAGET L M ERICSSON (PUBL), Stockholm (SE)

(21) Appl. No.: 13/765,865

(22) Filed: Feb. 13, 2013

Related U.S. Application Data
(60) Provisional application No. 61/598,161, filed on Feb. 13, 2012.

(51) Int. Cl. G06F 15/177

(52) U.S. Cl. CPC G06F 15/177
USPC 709/221

(57) ABSTRACT

Upon attachment of a machine-to-machine (M2M) device to a network, the access network determines which service provider to connect the device to. During an initial attachment process, the device can be configured so that it only will connect to a defined M2M service provider.

### CROSS REFERENCE TO RELATED APPLICATION

This application claims the benefit of priority to U.S. Provisional Patent Application No. 61/598,161 entitled “M2M Service Enablement over Access Networks”, filed on Feb. 13, 2012, the contents of which are expressly incorporated herein by reference.

### TECHNICAL FIELD

This disclosure relates generally to enablement of Machine-to-Machine service in mobile networks.

### BACKGROUND

Machine to Machine (M2M) devices and M2M service providers (M2M SPs) are beginning to proliferate. This is enabling a so-called Internet of connected things that makes available services and insights not previously possible. As the number of devices and interconnections increases so do both the number of problems associated with managing the devices, and the business opportunities for the M2M SPs and the Access Network (AN) operators.

Whether they are mobile, such as sensors in transportation systems, or fixed in locations such as on a utility meter, devices are being connected to each other and to network services. However, a problem has arisen in that as the number of devices increases the problems of managing the devices also grows. Furthermore, the manner in which devices connect to a network can affect how they are managed.

As there is a great demand for connected devices to be able to make use of a cellular data network and not just a wireless network interface such as WiFi (IEEE 802.11), another problem is raised in how these devices will be registered and configured for access to different access network providers as well as M2M service providers. The Access Network provider may be a Service Provider, but in other scenarios they may only have a business relationship.

M2M devices are becoming more commonplace, and there is increasing standardization in the manner in which the M2M devices will communicate with M2M SPs over ANs. This is enabling the proliferation of both M2M SPs and M2M devices that are directly sold to end users. These devices may not be pre-provisioned for service with a particular M2M SP. Even when the devices are pre-provisioned for service with an M2M SP, the AN doesn't know how the M2M SP wants the device configured on the access network, how the M2M SP wants access rights restricted to control traffic, or how to configure billing arrangements. This information must be obtained for proper functioning, but often cannot be obtained from the device.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided, a method of subscription configuration at a network service control layer entity in an access network. The method comprises the steps of receiving, from a device connected to the access network, a registration request containing a subscription identifier; determining, in accordance with the received registration request, a service provider associated with the device; transmitting, on behalf of the device, a registration request to a determined service provider; and modifying a subscription configuration associated with the device in the access network in accordance with a received response to the transmitted registration request.

In an embodiment of the first aspect of the present invention, the step of receiving includes receiving a request over a bearer in the access network having the network service control layer entity defined as the access point name (APN). In another embodiment, wherein the subscription identifier is a machine to machine subscription identifier and the step of determining includes extracting a service provider identity from the machine to machine subscription identity. In a further embodiment, the transmitted registration request is created in accordance with the received registration request. In another embodiment, the step of transmitting includes transmitting an external identifier to the determined service provider, the external identifier being uniquely allocated to the subscription associated with the device and the service provider associated with the subscription. In another embodiment of the first aspect, the step of modifying includes modifying a subscription profile stored at a Home Subscriber Server. In a further embodiment, the step of modifying includes modifying a subscription policy profile. In another embodiment, the step of modifying includes modifying the subscription configuration in the access network in accordance with a Service Level Agreement associated with the determined service provider. In a further embodiment, the step of modifying includes restricting available network access rights associated with the device. In another embodiment, the device is a Machine-to-Machine terminal device, and the service provider is a Machine-to-Machine service provider.

In a second aspect of the present invention, there is provided an access network Machine-to-Machine service control layer entity comprising a network interface, a processor and an instruction repository. The network interface can be used to communicate with a connected machine-to-machine device and a machine-to-machine service provider. The processor executes stored instructions. The instruction repository stores instructions that when executed cause to processor to receive, over the network interface, a registration request containing a subscription identifier from the machine-to-machine device, determine that the received registration request is associated with the machine-to-machine service provider; transmit a registration request to the service provide on behalf of the device over the network interface, and modify a subscription configuration associated with the device in the access network in accordance with a response to the transmitted registration request received over the network interface.

In a third aspect of the present invention, there is provided a method of proxying communications between a machine-to-machine device connected to an access network and a machine-to-machine service provider, at a network service control layer entity in the access network. The method comprises the steps of receiving a data transmission from the device containing a subscription identifier; selecting the machine-to-machine service provider from a plurality of machine-to-machine-service providers, upon determining that the selected machine-to-machine service provider does not make use of an interworking function, creating a binding uniquely associating the device with the data transmission and selected machine-to-machine service provider; transmitting, to the selected service provider, a message determined in accordance with the received data transmission; receiving a response to the transmitted message; and transmitting to the device uniquely associated with the received response by the created binding, a response to the received data transmission.

In an embodiment of the third aspect of the present invention, the step of selecting the service provider includes selecting the service provider in accordance with the subscription identifier. In another embodiment, the step of selecting the service provider includes selecting the service provider in accordance with access network subscription information associated with the device. In a further embodiment, step of creating a binding includes associating an external identifier assigned to the device.

In a fourth aspect of the present invention, there is provided an access network Machine-to-Machine service control layer entity comprising a network interface, a processor and an instruction repository. The network interface allow for communication with a connected machine-to-machine device and a machine-to-machine service provider. The processor executes instructions stored in the instruction repository, and the instruction repository stores instructions that when executed cause to processor to select the machine-to-machine service provider in accordance with a subscription identifier contained in a data transmission received over the network interface from the machine-to-machine device, create a binding uniquely associating the device with the data transmission and the selected machine-to-machine device upon determining that the selected machine-to-machine service provider does not make use of an interworking function, transmit to the selected service provider a message determined in accordance with the received data transmission, transmit a response to the received data transmission determined in accordance with a response received over the network interface from the service provider, the transmitted response sent over the network interface and sent to the device.

In a fifth aspect of the present invention, there is provided a method for obtaining network configuration parameters at a machine-to-machine device. The method comprises the steps of connecting to an access network; receiving temporary access network configuration parameters in response to the connection; registering with a machine-to-machine service provider over the access network using the received temporary access network configuration parameters; receiving a response to the registration with the machine-to-machine service provider; and setting permanent access network configuration parameters in accordance with the received response.

In an embodiment of the fifth aspect of the present invention, the method further comprises the step of selecting the machine-to-machine service provider from a list provided by the access network prior to the step of registering. In another embodiment, the access network is a radio access network. In a further embodiment, the temporary access network configuration parameters include an access point name, APN, specifying a node in the access network, and optionally the permanent access network configuration parameters include an APN specifying a node associated with the service provider, or the APN can specify a node in the access network.

In a sixth aspect of the present invention, there is provided a machine to machine device. The device comprises a network interface, a processor and an instruction repository. The network interface allows for communication with an access network. The processor executes instructions. The instruction repository stores instructions that when executed by the processor cause the processor to initiate a connection to the access network over the network interface, register with a machine-to-machine service provider through the access network using temporary access network configuration parameters received in response to the initiated connection, and to set permanent access network configuration parameters in accordance with a registration response received in response to the registration with the machine-to-machine service provider.

In a seventh aspect of the present invention, there is provided a method of configuring a machine-to-machine device for use of an access network. The method comprises the steps of receiving an initial attach from the device; transmitting temporary configuration parameters to the device; receiving a registration request from the device for service with a machine-to-machine service provider; transmitting a registration request to the service provider on behalf of the device; receiving a registration response from the service provider; and transmitting permanent access network configuration parameters, determined in accordance with the received registration response, to the device.

In an embodiment of the seventh aspect of the present invention, the temporary configuration parameters are selected to provide limited access to network resources which can optionally provide the device with proxied access to the service provider through a node in the access network. In another further embodiment, the method further includes the step of receiving, from the device, an explicit selection of the machine-to-machine service provider in response to transmitting a list of available machine-to-machine service providers to the device. In another embodiment the registration request transmitted to the service provider is generated in accordance with the received registration request. In a further embodiment, the temporary access network configuration parameters include an access point name, APN, specifying a node in the access network. In yet another embodiment, the permanent access network configuration parameters include an APN specifying a node associated with the service provider. In a further embodiment, the permanent access network configuration parameters include an APN specifying a node in the access network.

In an eighth aspect of the present invention, there is provided an access network machine-to-machine network service control layer entity. The entity comprises a network interface, a processor and an instruction repository. The network interface allows for communication with devices and service providers connected to an access network. The processor executes instructions. The instruction repository stores instructions that when executed by the processor cause the processor to transmit, over the network interface, temporary configuration parameters to a machine-to-machine device in response to an initial attach of the device to the access network, to transmit, over the network interface, a registration request to a machine-to-machine service provider on behalf of the device in response to receipt of a registration request from the device identifying the service provider, and to transmit, over the network interface, permanent access network configuration parameters to the device in response to receipt of a registration response from the service provider, the access network configuration parameters determining in accordance with the received registration response.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating a connectivity scenario;

FIG. 2 is a block diagram illustrating a connectivity scenario;

FIG. 3 is a block diagram illustrating a connectivity scenario;

FIG. 4 is a block diagram illustrating an exemplary node in the networks of FIGS. 1-3;

FIG. 5 is a call flow diagram illustrating an exemplary embodiment of a device being configured after an initial attach to the access network;

FIG. 6 is a call flow diagram illustrating an exemplary embodiment of a device using the access network as the M2M Service Provider being configured after an initial attach to the access network;

FIG. 7 is a call flow diagram illustrating an exemplary embodiment of a device communicating with an M2M Service Provider on a non-initial connection;

FIG. 8 is a call flow diagram illustrating an exemplary embodiment of a device communicating with an M2M Service Provider on a non-initial connection using an M2M NSCL as a proxy;

FIG. 9 is a call flow diagram illustrating an exemplary embodiment of a device not having a pre-selected M2M service Provider being configured after an initial attach to the access network;

FIG. 10 is a flow chart illustrating an exemplary method of configuring a machine-to-machine device; and

FIG. 11 is a flow chart illustrating an exemplary method of providing configuration information to a machine-to-machine device.

### DETAILED DESCRIPTION

The present invention is directed to a system and method for registering and configuring M2M devices on ANs for interaction with different M2M SPs.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

An M2M device connects to an M2M SP over an AN. The selection of the AN used by the M2M device is not germane to this discussion as it is a well understood field, and typically will be performed through either the insertion of a Subscriber Identity Module (or a variation thereof) or through other conventional means. The M2M device may be pre-configured to connect to a particular M2M SP, but when first attaching to the AN, this will likely not be apparent to the AN. The M2M device may not be preconfigured to a particular M2M SP, in which case during an initial attach to the AN, the AN must obtain an identification of the M2M SP to be used. It should be noted that in some scenarios that AN may also provide M2M SP functionality, while in others the AN is merely providing connectivity to the M2M device (the degree of connectivity provided may vary based on the business rules associated with the M2M SP which may complicate the initialization of the M2M device). In the following discussion, architectures in which the M2M SP is the same as the AN, the AN proxies all traffic to the M2M SP during an initial attach, and in which the AN proxies traffic for all communications between the M2M device sand the M2M SP will be discussed. Additionally, initial attach and configuration of an M2M device will be discussed in scenarios in which the M2M device is pre-configured to use a particular M2M SP and in which the M2M device does not have a preconfigured M2M SP.

The following discussion details a process that can be undertaken by an M2M device when it attaches to a cellular access network for the first time. This process can help to ensure that the M2M device acquires the proper and necessary information for M2M service purposes as well as help to ensure that the access network provider and the M2M service provider can enforce the proper subscription profile for the M2M device both at the access and the service level respectively. Furthermore this process can be used to ensure proper interworking between the access network provider and the M2M service provider in support of various connection and interaction models to fulfill various business agreements

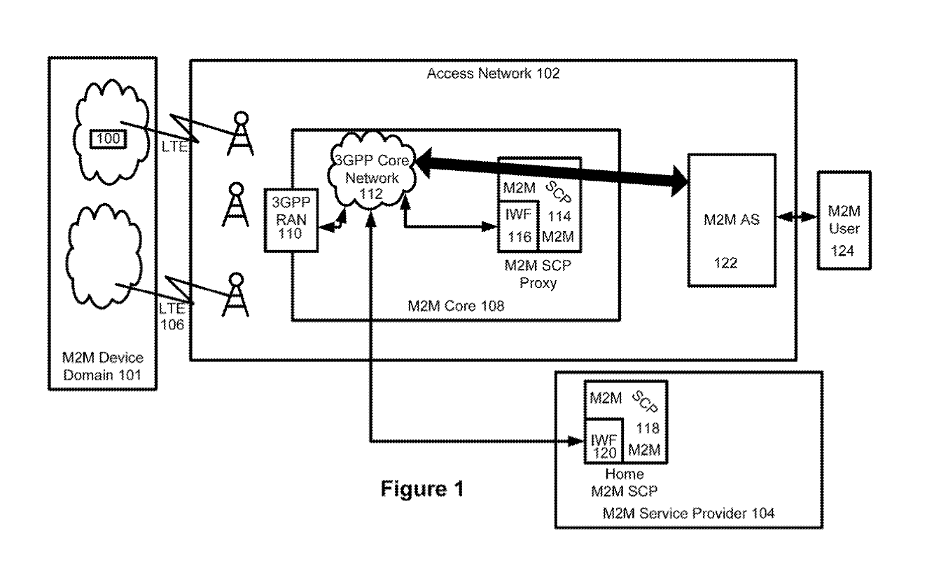

In the first scenario to be discussed, the access network provider will assumed to be the M2M service provider and is illustrated in FIG. 1. The bold double arrow indicates M2M traffic between the access network and the applicable M2M NSCL for this scenario.

An M2M Device 100, shown as residing in M2M device domain 101, connects to the AN 102, and if the M2M Device 100 is using an M2M SP that is different than the AN 102, it can connect through the AN 102 to the M2M SP domain 104. The connection to AN 102 is shown here as being a 3GPP complaint radio access connection such as an LTE connection 106. One skilled in the art will appreciate that although reference is made herein to a device, it could be the unique pairing of a device and application that is subject to this configuration process. Furthermore, the device could be a gateway acting on behalf of a plurality of different devices. The M2M core 108 interacts with the M2M device 100 through the user of an interface such as 3GPP RAN interface 110. One skilled in the art will appreciate that this discussion makes use of terminology and elements specific to an access network using a radio air interface and an evolved packet core, however it will be apparent to those skilled in the art that other access networks can be used with the required variations. In one such example, M2M devices can connect through a gateway that makes use of a wired connection, such as that provided by a DOCSIS compliant cable modem, or another such fixed access technology. Those skilled in the art will appreciate that where the AN 102 provides M2M SP functionality, the M2M AS 122 can be accessed through the 3GPP Core Network 112 which directs traffic through the M2M SCP proxy 114 to the M2M AS 122 The 3GPP Core network 112 allows interaction with an M2M Service Provider 104 through its M2M SCP 118 which connects to the 3GPP Core Network through Interworking Function (IWF) 120. The Home M2M SCP 118 provides access to M2M applications and services (not illustrated in this figure).

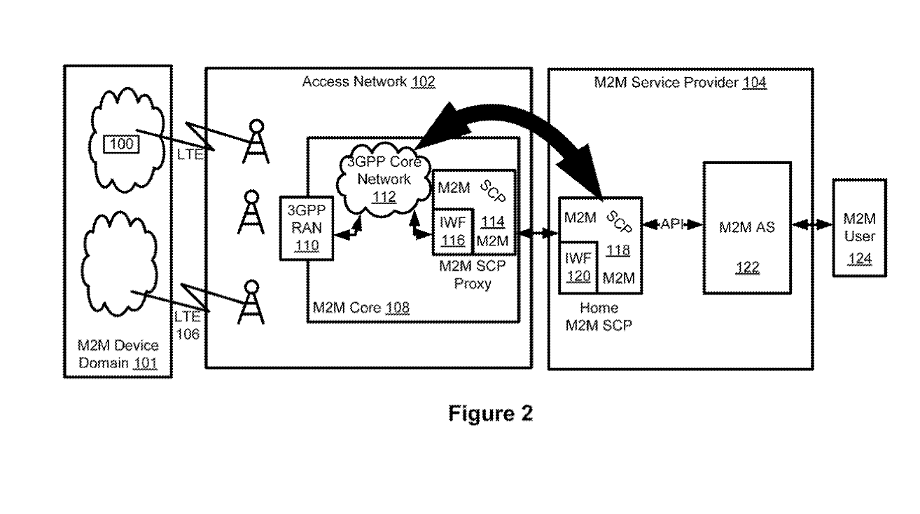

In the second scenario, the access network provider is not the M2M service provider, and no proxy is used. In this scenario, as illustrated in FIG. 2, the M2M Service Provider has a business agreement with the Access Network Provider. The M2M Service Provider also interacts with the access network via an IWF, owned by the M2M service provider, which is compliant to the specific access network applicable standard in that regard. The bold double headed arrow indicates the M2M traffic between the access network and the applicable M2M NSCL for this scenario

As shown in FIG. 2, an M2M Device 100, in the M2M Device Domain 101 communicates with the M2M Service Provider 104 through the Access Network 102. As illustrated M2M Device connects to Access Network 102 through the use of a radio access network link, such as LTE connection 106. In the M2M core 108, the traffic is first handled by an 3GPP RAN 110, and handed to the 3GPP Core Network 112. During the initial attach of a device 100, the M2M SCP Proxy 114, with IWF 116 serves as a proxy for connecting the device to the M2M Service Provider 104. The proxied connection is received by the home M2M SCP 118 and its IWF 120. Through an API, the home M2M SCP 1218 provides access to an M2M Application Server 122, which is accessed by M2M user 124. After the initial attach and configuration of the device 100 in AN 102, subsequent communication is routed directly from the 3GPP core network 112 to the home M2M SCP 118 which is marked by the bold arrow.

In the third scenario, the access network provider is not the M2M service provider, but a proxy is used so that traffic from the terminal device is routed in a manner that provides the Access Network Operator control and security, while reducing an implementation burden on the M2M SP.

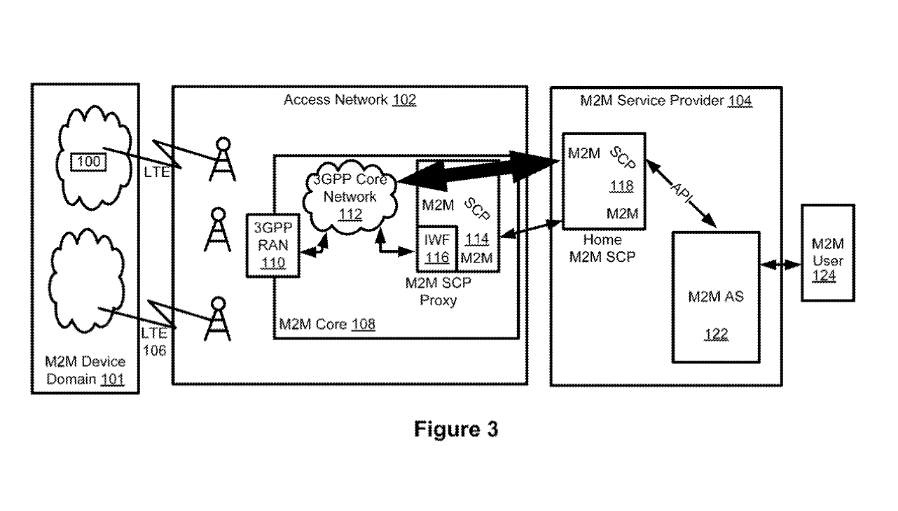

In this case as shown in FIG. 3, the M2M SP typically has a business agreement with the Network Access Provider. However, the M2M SP does not interact with the Access Network Provider via an IWF. Rather all M2M traffic to the M2M SP is proxied via the M2M NSCL of the Access Network Provider. This saves the burden for the M2M SP to implement any IWF support. Note that this capability requires support by the Access Network Provider. As illustrated in FIG. 3, this architecture is similar to that shown in FIG. 2, but instead of a connection between the 3GPP Core Network 112 and the home M2M SCP 118, the traffic is routed through the M2M SCP Proxy 114 to the Home M2M SCP 118. The Home M2M SCP 118, in this embodiment, would not need to implement any IWF support.

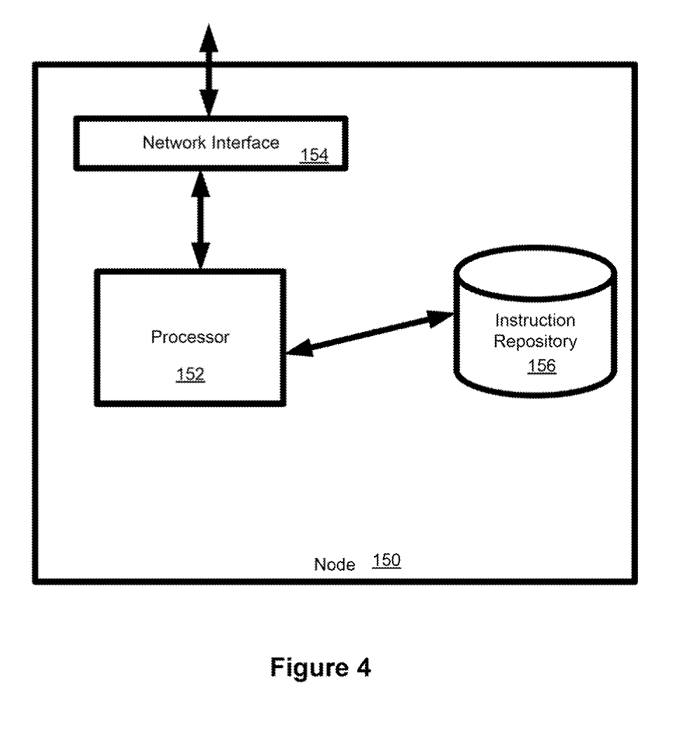

One skilled in the art will appreciate that FIG. 4 illustrates a node 150 having a processor 152, a network interface 154 and an instruction repository 156. Such a node 150 can be used to implement the methods of the current invention at various places in the network, including at the Access Network M2M SCP proxy. One skilled in the art will also appreciate that the nodes discussed in the figures can be abstractly viewed as a series of functional elements. Such functional elements can be implemented on a general purpose computer such as that illustrated in FIG. 4.

It should be understood that to enable dynamic selection of an M2M SP, the access network provider can act as a broker. This can allow the M2M device to dynamically select an M2M SP with whom the access network has business agreements. The dynamic selection of an M2M SP can then be used by the access network to select from the connectivity scenarios illustrated in FIGS. 1-3 and discussed above.

Procedures for enablement of M2M services will now be discussed with reference to nodes illustrated in FIGS. 1-3. Message flow diagrams will be used in conjunction with the following discussion.

In providing a service enablement process, it may be advantageous in certain scenarios to allow an M2M device to acquire at least some of the necessary information to receive a desired service from a desired M2M SP for the scenarios outlined in FIGS. 1-3. In other exemplary embodiments, it may be advantageous, but not essential, this information be obtained during the initial network attachment process. In other scenarios, the M2M SP may be implemented such that it acquires an M2M external identifier used for interaction between the M2M SP and the access network. This identifier is typically allocated by the Access Network Provider. This can be obtained through the M2M device initially connecting to the M2M NSCL of the access network, or other means. An exemplary manner in which this is done will be discussed below in more detail. This may occur during the initial network attachment of the M2M device. Alternatively, it may be beneficial to enable the access network to enforce the access subscription profile related to an M2M device and to update it appropriately after initial network attachment.

In the following exemplary service enablement processes, the access network is able to distinguish an M2M subscription from other types of access subscriptions. Another feature of a below-illustrated exemplary embodiment is that the M2M device can initially be allowed to establish a bearer to the access network NSCL for bootstrapping purposes. Finally, the M2M device, in some exemplary embodiments, can be pre-provisioned with the M2M Subscription ID allocated to it by the M2M SP before any bearer is established. This M2M subscription ID can then be passed to the access network during the bearer establishment procedure.

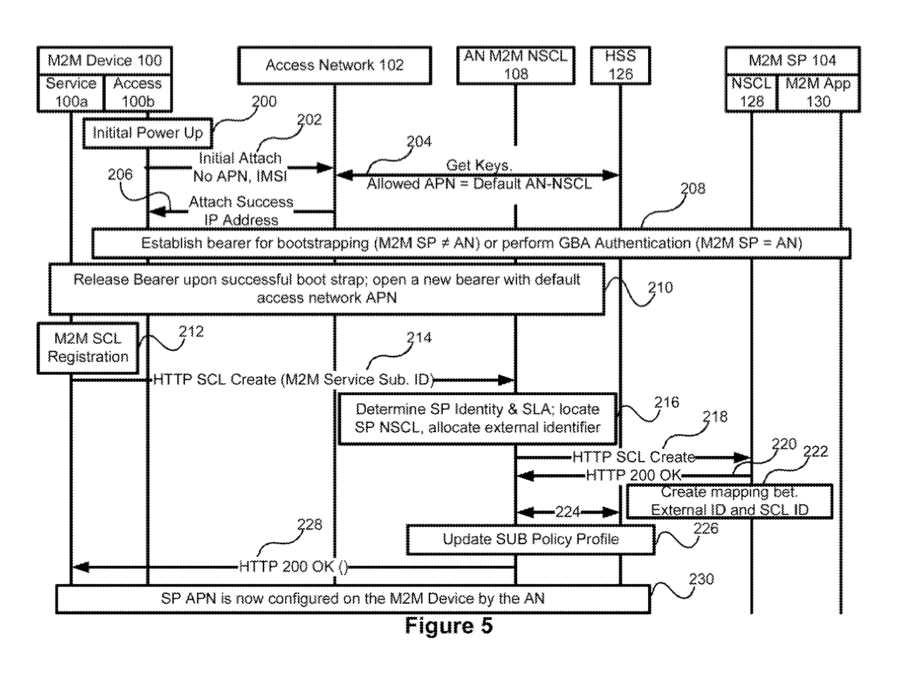

The call flow diagram of FIG. 5 illustrates an exemplary method for the interaction processing that occurs during the first attachment of an M2M device to the access network. An M2M Device 100 has a service component 100a and an access component 100b. The M2M device 100 connects to the Access Network 102 which has both an AN Network Service Control Layer (NSCL) 108 and a Home Subscriber Server (HSS) 126. Using AN 102 the M2M Device connects to the M2M SP 104 which has its own NSCL 128 and an M2M Application 130 (which would typically be run on an M2M AS 122).

In the exemplary embodiment of FIG. 5, the M2M device 100 powers up in step 200 and attaches to AN 102 for the first time in step 202. During the initial attach, the M2M Device 100 does not provide a default Access Point Name (APN) but does provide an identifier such as its IMSI to AN 102. One skilled in the art will appreciate that other identifiers could also be used, but for the sake of simplicity, the following discussion will only discuss the use of an IMSI. AN 102 initiates device access authentication 204 to the HSS 126 to obtain keys. In this request, a default APN is specified, as illustrated in this exemplary embodiment, the default APN is set to the APN associated with the Access Network NSCL 108 as well as a restricted list of addresses of servers for bootstrapping purposes based on service level agreements (SLA) between the AN 102 and its M2M SP partners. Upon completion of device access authentication 204, the M2M Device 100 is authenticated for network access, and message 206 reporting the attach success and other information such as an Internet Protocol (IP) address is provided. In step 208, the M2M device 100 establishes a bearer with the M2M SP 104 for boot strapping purposes. This bearer is created using the default bearer from the default access subscription profile, and allows the device 100 to obtain the necessary security credentials from its M2M service provider 104. The AN 102 will provide limited connectivity to the M2M device 100 to allow it to acquire the necessary bootstrapping information. Once the bootstrapping process is completed, the M2M device 100 releases the default bearer and can establish a new bearer to communicate with the M2M SP 104 for acquiring the desired service as shown in step 210. One skilled in the art will appreciate that during the initial attach, the M2M device 100 can be provided with a restricted connectivity so that it is only able to establish a bearer to the AN M2M NSCL 108. Such a restriction can be used to allow the Access Network Provider to be able to update the M2M device access profile with the required information for enforcement during subsequent attachment to the access network 102, for interaction between the M2M device 100 and its M2M service provider 104. The M2M device 100 can simply establish a new bearer in step 210 and the access network 102 can ensure that this bearer is targeted to its own M2M NSCL 108. In step 212, the M2M device 100 initiates an M2M SCL registration process. Using message 214, the M2M Device Service Layer 100a sends its M2M Service subscription identifier and other information to the AN NSCL 108. The M2M NSCL 108 can then verify that it has a business relation with the identified M2M SP 104. The identification of the M2M SP 104 can be extracted from the M2M Subscription ID contained in message 214. Upon obtaining the M2M SP identity, a service level agreement (SLA) specific to the M2M SP 104 can be retrieved, and an external identifier can be assigned to the M2M device 100 in step 216. This external identifier, along with the M2M Subscription ID is then transmitted by the AN NSCL 108 to the M2M NSCL 128 in message 218. One skilled in the art will recognize this as the AN NSCL 108 proxying the registration request to the M2M SP NSCL 128 on behalf of M2M Device 100. In step 220, the M2M SP NSCL 128 provides notification of successful registration to the AN NSCL 108, and can then maintain a mapping between the provided external identifier and the SCL id of the M2M device 100 in process 222. Upon successful registration, the access network M2M NSCL 108 can update the M2M device access profile stored by the HSS 126 in step 224, with the necessary access information related to the M2M SP 104. This allows the Access Network Provider to enforce that subsequent attachment by the M2M device 100 is only permitted to the specific M2M SP 104. Once the M2M network access profile is successfully updated in step 226, the M2M NSCL registration outcome can be proxied back to the M2M device 100 as shown by message 228. For subsequent attachment by the M2M device 100, this initial attachment configuration can be bypassed as the necessary information for the configuration of connections from the M2M device 100 is now provisioned in the access profile for the M2M device 100. In addition, the M2M SP 104 will possess the external identifier needed for interworking with the access network 102. In step 230, the necessary access network information (e.g. Access Point Name—APN for 3GPP accesses) that allows the M2M device 100 to establish a bearer with the M2M SP 104 for subsequent network attachment can be configured in the M2M device 100. The details of step 230 are not necessarily germane to the discussion.

It is important to note that the manner in which the connectivity provided to an unconfigured device is implemented, as described above, during the initial attach process is exemplary. The described approach should not be considered limiting. One skilled in the art will appreciate that full access could be given to the device, although a number of business issues would arise as a result. Other approaches can be used to achieve the same effect. For example the M2M device can be provisioned initially with an APN that allows it limited connectivity to a handful of addresses for bootstrapping purposes. These addresses are known to the AN based on SLAs it has with its business M2M SP partners. Once the bootstrapping procedure is completed, any attempt by the M2M device to connect to its M2M SP 104 will reroute the connection to the AN M2M NSCL 108. This approach can be used to obtain a similar outcome with fewer steps.

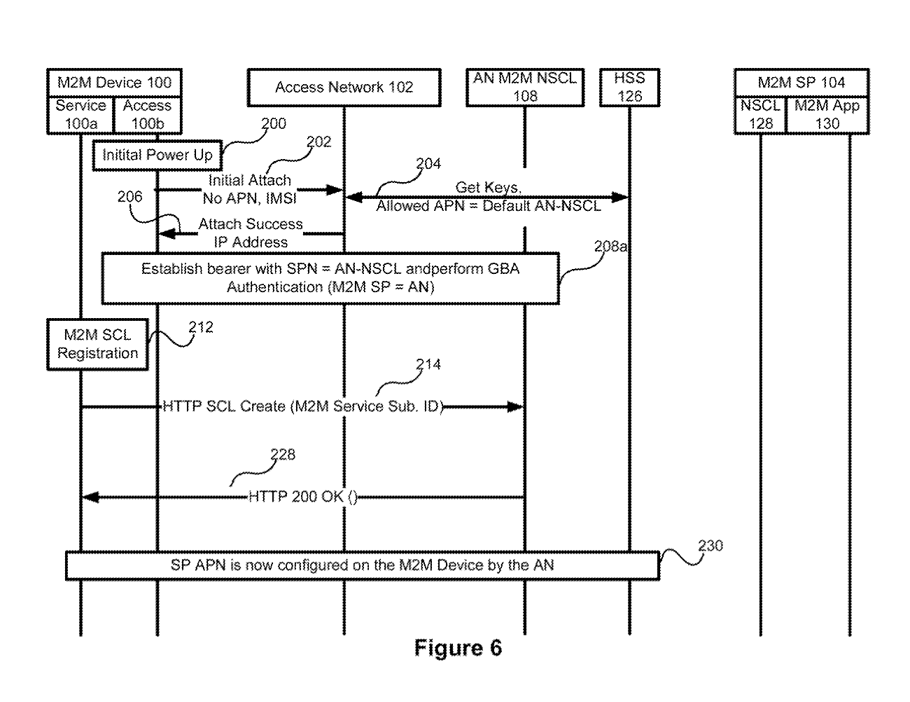

One skilled in the art will appreciate that in step 208, a bearer is established when it is clear that the M2M SP 104 is a distinct entity from AN 102. Where the AN serves as the M2M SP, a generic bootstrap architecture procedure can be employed, as the M2M device 100 does need to perform the bootstrapping procedure. Such a scenario is shown in FIG. 6. As illustrated, the M2M Device 100 powers on in step 200 and transmits an attach request to AN 102 in step 202. The An 102 and the HSS 126 exchange data in step 204, and the attach success is reported to the M2M device 100 in step 206, just as described with respect to FIG. 5. In step 208a, a bearer is established with the default network APN that is associated with the AN, and a GBA procedure is performed. In step 212, the M2M SCL registration is started, and message 214 is sent from the M2M Device Service layer 100a to the AN SCL 108. The AN SCL 108 does not need to communicate with an external M2M SP 104, and can thus simply return the registration confirmation in message 228. The process completes in step 230 as described above. It can be seen from the above that the M2M device 100 is initially pre-configured to use GBA or to perform bootstrapping and as such trigger appropriate steps in accordance with either FIG. 5 or FIG. 6

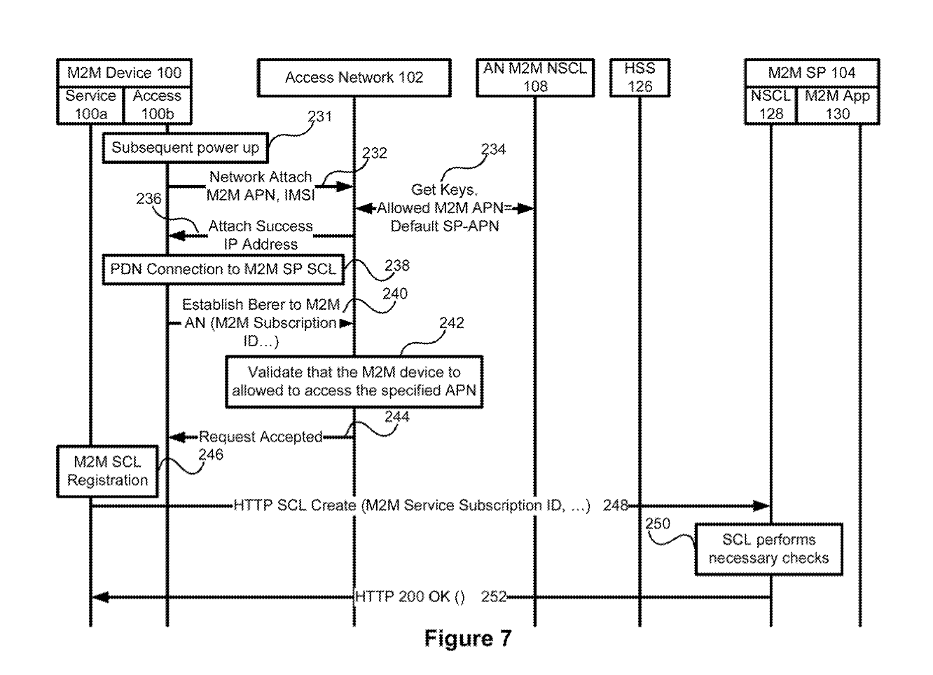

After the initial attach process as described above, the M2M device 100 can re-connect to the network, and the manner in which the data is transmitted from the M2M device 100 to the M2M SP 104 is subject to what arrangements have been made between the M2M SP 104 and the AN operator. FIG. 7 illustrates the scenario in which interworking functions are used to allow traffic to proceed from the AN Operator to the M2M SP. This is the scenario illustrated in FIG. 2.

The call flow of FIG. 7 illustrates exemplary steps that can be undertaken at an M2M device subsequent to attaching to the access network. In step 231, the M2M device is powered up, and initiates an access network connection with a request for a network attach that specifies the M2M APN, configured in the M2M device 100 as an outcome from FIG. 5 or FIG. 6, and the IMSI, as shown in 232. The identification of the M2M APN is an indication to the AN 102, which receives requests 232, that this is not an initial attach. In bidirectional data flow 234, the AN 102 communicates with HSS 126 to authenticate the M2M device 100. In 234, the AN 102 obtains keys, and sets the allowed M2M APM as the APN allocated to the M2M SP (also referred to as SP-APN), and obtains the access profile stored in the HSS 126 for enforcement purposes. Notification of the successful attach, along with the assigned IP address is provided in step 236. The M2M Device access layer 100a then initiates a PDN connection to the M2M SP NSCL in step 238. To that effect, in step 240, the M2M device 100 establishes the allowed default bearer according to the access subscription profile to allow it to connect to its M2M SP in step 240. In step 242, the AN validates that the M2M device is allowed to access the specified APN and provides an indication of request acceptance in step 244. In step 246, the M2M device service layer 100a begins the M2M SCL registration process 246. In message 248, the M2M Device 100 sends to the M2M SP NSCL 128 an SCL registration request, through an HTTP SCL CREATE, request containing the service subscription ID and other data. In step 250, the M2M SP NSCL 128 performs any necessary checks and then confirms registration in 252. One skilled in the art will appreciate that although it proxied data during the initial attach, the access network operator, in the scenario illustrated in FIG. 7, does not proxy data between the M2M device 100 and the M2M SP 104, and is rather completely transparent.

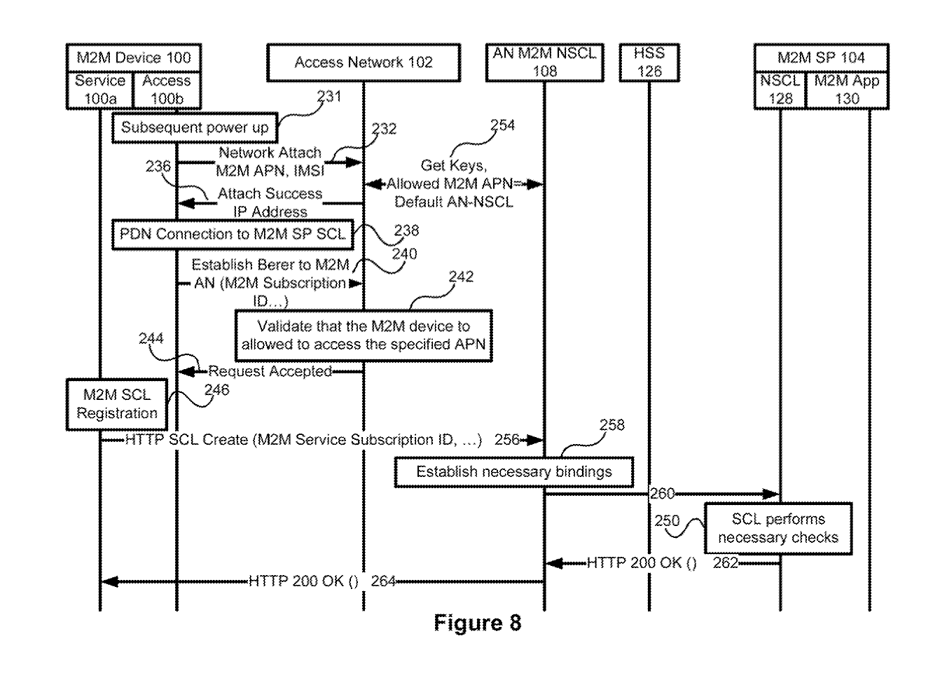

For subsequent network attachment of an M2M device in a proxy connection scenario, FIG. 8 illustrates an exemplary call flow that corresponds to a message flow that may occur in the architecture of FIG. 3. Steps 231 and 232 are carried out in a similar fashion to that explained above with respect to FIG. 7. While in step 234, the APN was set to the SP-APN, in step 254, the M2M APN is set to the default AN-NSCL 108. Steps 236, 238, 240, 242, 244 and 246 are carried out as described above. It should be noted that the bearer established in 240 sets the M2M APN to be the AN-NSCL. Following the initiation of the M2M SCL Registration of the M2M device 100 in step 246, the M2M Device Service layer 100a sends an SCL registration request 156, through an HTTP SCL CREATE, request, to the AN NSCL containing the M2M Service subscription identifier and any other required information. In step 258, the AN NSCL 108 will establish the necessary bindings. These bindings are used to associate the M2M device 100 to M2M SP 104 which allows proper functioning of the proxy services. In step 260 the registration request is proxied by the AN NSCL 108 to the M2M SP NSCL 128. The M2M SP NSCL 128 performs necessary checks in step 250 as described above, and confirms registration to the AN NSCL 108 in message 262. The AN NSCL 108 then forwards the confirmation along to the M2M device service layer 100a in message 264.

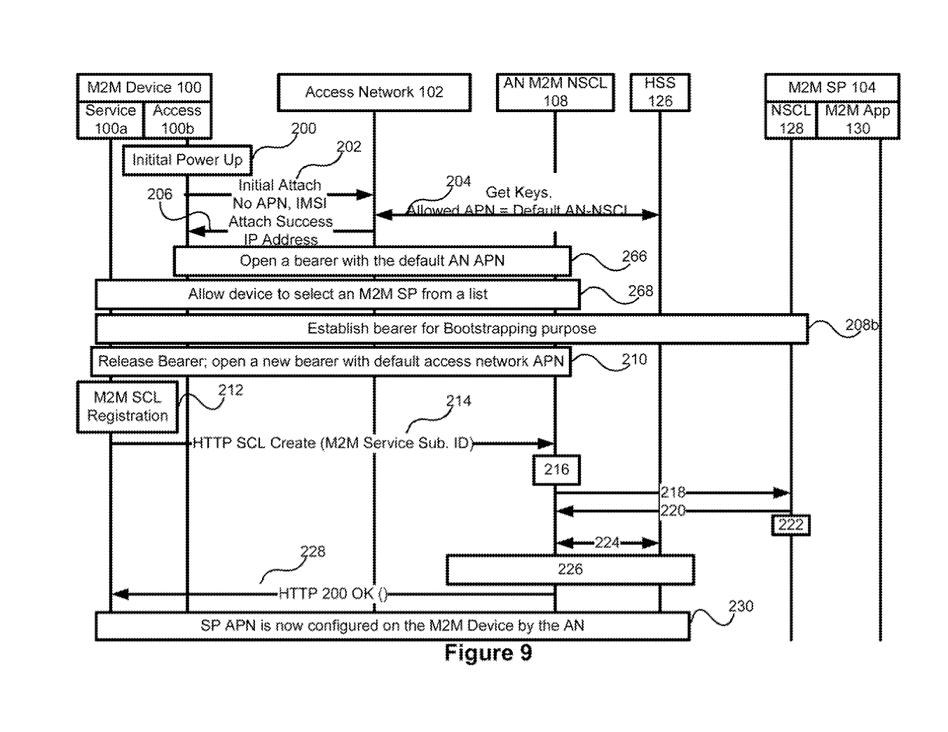

The call flow of FIG. 9 shows the interactions that take place when an M2M device attaches for the first time to an access network, but does not have a pre-selected M2M SP. The AN can provide the M2M device with a list of available M2M SPs so that the M2M device can be configured. This may be referred to as the dynamic selection of an M2M SP broker scenario. As shown in FIG. 9, the M2M device 100 is powered on, attaches to the network and is authenticated for network access in steps 200, 202, 204 and 206 as described above with respect to FIG. 5. In step 266, the M2M Device access layer 100b establishes a bearer to the AN 102 using the default network access APN (which in this case is the AN NSCL 108). The AN NSCL can then, in step 268 provide the M2M Device Service Layer 100a with a list of available M2M SPs that are accessible through the AN 102, and with whom the AN has business agreements (including itself if it offers M2M services). The preferred M2M SP 104 is selected on the M2M Device 100 (either through a programming choice or through an operator interaction). Upon making the selection the M2M Device is provided the information needed to perform the bootstrapping. If the M2M SP is set to the AN, then the process would proceed to steps 212, 214, 228 and 230 as shown in FIG. 6. Where the selected M2M SP is different from the AN, the bearer for bootstrapping purposes is established in step 208b between the M2M Device Service Layer 100a and the M2M SP NSCL 128. From this point, the process continues to steps 210, 212, 214, 216, 218, 220, 222, 224, 226, 228 and 230 as described in FIG. 5. (Dilip please fix step 228 in FIG. 9. It should be like the rest HTTP 200 OK

One skilled in the art will appreciate that the subsequent device attachment to the network call flow is effectively identical to that of the subsequent attaches for the cases described above, that one skilled in the art will appreciate how it is implemented. As a result, it will not be discussed in further detail at this time.

One skilled in the art will appreciate that the term “proxied” is used as a verb to indicate that a data is transferred from one node to another through a proxy.

The M2M Subscription identifier preferably identifies the M2M subscription assigned to the M2M device 100, and does so uniquely. The M2M Subscription Identifier may be owned by the M2M service provider 104 and can change if the M2M service provider is changed. The M2M subscription identifier can identify the M2M SP as well.

The subscription ID may be assigned and verified during the attachment process, and can be pre-configured in the device or assigned to a device during the first attach, as part of the bootstrapping process.

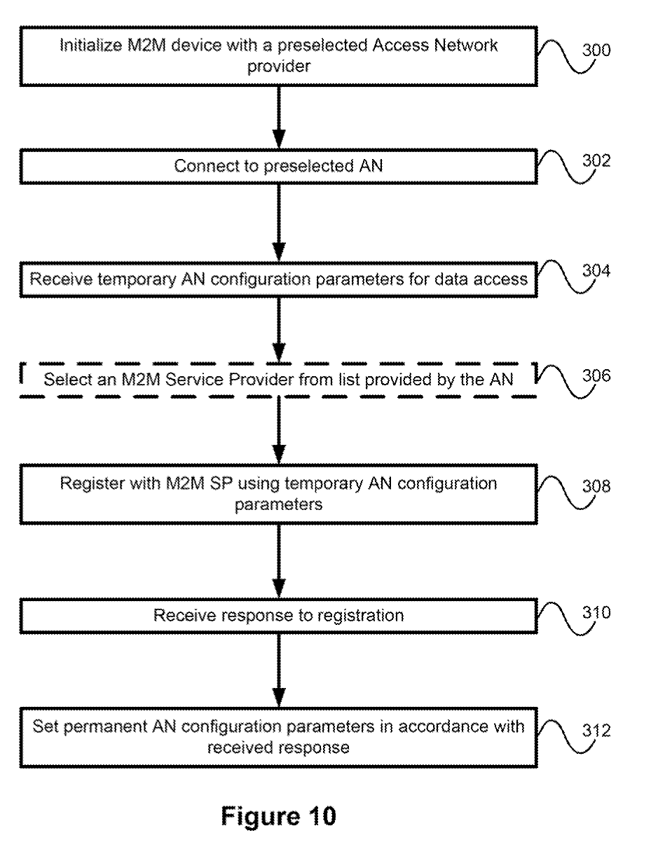

The processes described above will now be discussed from the perspective of the M2M device 100 which connects to AN 102. As shown in FIG. 10, an M2M device is initialized with a preselected AN provider as shown in step 300. As noted above, the selection of an AN provider is typically done through the insertion of a Subscriber Identity Module, or its equivalent, or through an on-device configuration option. In step 302, the M2M device connects to the preselected AN, and in response it receives, in step 304, a set of temporary configuration parameters for data access. If the device does not already have a selected M2M Service Provider, it can optionally be provided a list and in optional step 306 selects the M2M Service Provider from the list. In step 308, the M2M Device registers with the M2M SP, either the one selected in step 306 or one pre-selected and pre-programmed prior to initialization, using the temporary AN configuration parameters. One skilled in the art will appreciate that from the perspective of the device, this is an M2M SP registration, and the device may not necessarily be aware that the AN is proxying any requests on its behalf. In step 310, a response to the registration is received. The response to the registration is then used in step 312 to set permanent AN configuration parameters. It should be apparent to those skilled in the art that a single M2M SP may have different arrangements with different AN operators, and the above described method allows individual devices to be configured for the different arrangements as needed.

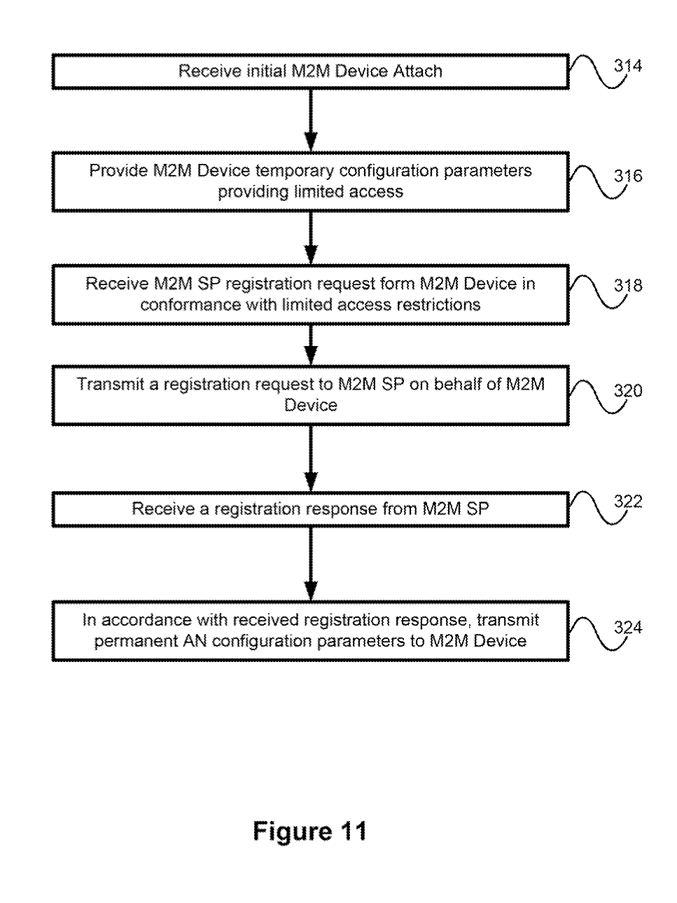

FIG. 11 illustrates a method from the perspective of a node in the AN that coincides with the method of FIG. 10. In step 314, an initial M2M device attach is received. Responsive to the received initial device attach, a set of temporary configuration parameters are transmitted to the M2M device in step 316. The temporary configuration parameters are established to restrict the access provided to the M2M Device prior to its permanent configuration. In step 318, an M2M SP registration request is received from the M2M device. This registration request is received in accordance with the limited access restrictions created by the temporary configuration parameters. A registration request is then sent to the M2M SP on behalf of the M2M device in step 320. This registration request is based on the received registration request, but may be modified by the AN as appropriate. In step 322, a registration response is received from the M2M SP. This registration response will include information that specifies billing details and approved access rights, as well as the manner in which the M2M device can access the M2M SP. Based on this information in the registration response, a permanent set of AN configuration parameters is determined and is transmitted to the M2M Device in step 324. Those skilled in the art will appreciate that, as shown in the earlier call flow diagrams, the AN can set its own configuration parameters based on the interaction with the M2M SP as well, but from the perspective of the interaction between the M2M device and the AN, this is not necessary.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of subscription configuration at a network service control layer entity in an access network, the method comprising:
receiving, from a device connected to the access network, a registration request containing a subscription identifier;
determining, in accordance with the received registration request, a service provider associated with the device;
transmitting, on behalf of the device, a registration request to a determined service provider; and
modifying a subscription configuration associated with the device in the access network in accordance with a received response to the transmitted registration request.

2. The method of claim 1 wherein the step of receiving includes receiving a request over a bearer in the access network having the network service control layer entity defined as the access point name (APN).

3. The method of claim 1, wherein the subscription identifier is a machine to machine subscription identifier and the step of determining includes extracting a service provider identity from the machine to machine subscription identity.

4. The method of claim 1 wherein the transmitted registration request is created in accordance with the received registration request.

5. The method of claim 1 wherein the step of transmitting includes transmitting an external identifier to the determined service provider, the external identifier being uniquely allocated to the subscription associated with the device and the service provider associated with the subscription.

6. The method of claim 1 wherein the step of modifying includes modifying a subscription profile stored at a Home Subscriber Server.

7. The method of claim 1 wherein the step of modifying includes modifying a subscription policy profile.

8. The method of claim 1 wherein the step of modifying includes modifying the subscription configuration in the access network in accordance with a Service Level Agreement associated with the determined service provider.

9. The method of claim 1 wherein the step of modifying includes restricting available network access rights associated with the device.

10. The method of claim 1 wherein the device is a Machine-to-Machine terminal device, and the service provider is a Machine-to-Machine service provider.

11. An access network Machine-to-Machine service control layer entity comprising:
a network interface for communicating with a connected machine-to-machine device and a machine-to-machine service provider;
a processor for executing instructions; and
an instruction repository for storing instructions that when executed cause to processor to receive, over the network interface, a registration request containing a subscription identifier from the machine-to-machine device, determine that the received registration request is associated with the machine-to-machine service provider; transmit a registration request to the service provide on behalf of the device over the network interface, and modify a subscription configuration associated with the device in the access network in accordance with a response to the transmitted registration request received over the network interface.

12. A method of proxying communications between a machine-to-machine device connected to an access network and a machine-to-machine service provider, at a network service control layer entity in the access network, the method comprising:
receiving a data transmission from the device containing a subscription identifier;
selecting the machine-to-machine service provider from a plurality of machine-to-machine-service providers;
upon determining that the selected machine-to-machine service provider does not make use of an interworking function, creating a binding uniquely associating the device with the data transmission and selected machine-to-machine service provider;
transmitting, to the selected service provider, a message determined in accordance with the received data transmission;
receiving a response to the transmitted message; and
transmitting to the device uniquely associated with the received response by the created binding, a response to the received data transmission.

13. The method of claim 12 wherein the step of selecting the service provider includes selecting the service provider in accordance with the subscription identifier.

14. The method of claim 12 wherein the step of selecting the service provider includes selecting the service provider in accordance with access network subscription information associated with the device.

15. The method of claim 12 wherein the step of creating a binding includes associating an external identifier assigned to the device.

16. An access network Machine-to-Machine service control layer entity comprising:
a network interface for communicating with a connected machine-to-machine device and a machine-to-machine service provider;
a processor for executing instructions; and
an instruction repository for storing instructions that when executed cause to processor to select the machine-to-machine service provider in accordance with a subscription identifier contained in a data transmission received over the network interface from the machine-to-machine device, create a binding uniquely associating the device with the data transmission and the selected machine-to-machine device upon determining that the selected machine-to-machine service provider does not make use of an interworking function, transmit to the selected service provider a message determined in accordance with the received data transmission, transmit a response to the received data transmission determined in accordance with a response received over the network interface from the service provider, the transmitted response sent over the network interface and sent to the device.
